(19) United States
(12) Patent Application Publication
(10) Pub. No.: US 2009/0119283 A1
(43) Pub. Date: May 7, 2009

(54) System and Method of Improving and Enhancing Electronic File Searching

(76) Inventors: Donald J. Muehlbauer, (US); Steven J. Eisenhauer, (US)

Correspondence Address: Securience, LLC, 10437 Innovation Drive, Suite 522, Wauwatosa, WI, 53226, US

(21) Appl. No.: 12/140,256

(22) Filed: Jun. 16, 2008

Related U.S. Application Data
(60) Provisional application No. 60/985,696, filed on Nov. 6, 2007.

(51) Int. Cl. G06F 17/30

(52) U.S. Cl. 707/5; 707/E17.014

(57) ABSTRACT

The invention is a system and a method for improving and enhancing electronic file searching, the system employing the method, and the method comprising (a) accepting context as input; and (b) reducing context to keywords; and (c) weighting keywords; and (d) searching electronic data store(s) using said weighted keywords; and (e) displaying search results.

### CROSS-REFERENCE TO RELATED APPLICATIONS

This application claims the benefit of provisional patent application Ser. No. 60/985,696 filed Nov. 6, 2007.

### DRAWING SHEETS

Drawing and description reference numerals follow:
10 Searcher/Initiator (human user, computer process or service that is searching the internet or other electronic resource)
12 Group of possible data sources
12a Data source: Word Processor Document
12b Data source: Spreadsheet
12c Data source: Portable Document Format (PDF)
12d Data source: Database
12e Data source: Website/Webpage
12f Data source: Manual Input
12g Data source: Others
14a Manual Input Box or File Selection Control
14b Automatic Reader/Analyzer
16 Context data store (sentence, paragraph, document, area of text around cursor, important area of text, etc.)
18 Group of possible textual analysis processes
18a Textual analysis process: Natural language processing
18b Textual analysis process: Proper Name extracting
18c Textual analysis process: Others
20a Keyword(s) data store (search terms, proper names, etc. and/or weighted rankings)
20b Modified keyword(s) data store (search terms, proper names, etc. and/or weighted rankings)
22 Search query/queries
24 Group of resource searches
24a Resource search: Traditional search engine (Google, Yahoo!, MSN, etc.)
24b Resource search: Industry/Content/Category Specific Databases (LexisNexis, newspaper collections, etc.)
24c Resource search: Others
26 Results (Websites, Images, Videos, Audio, Databases, etc.)
28 Group of Results Displays and Processors
28a Results Display: List Display
28b Results Display: Grid Display
28c Results Display: Web Display
28d Results Display: Others
28e Results Processor: Organize, Arrange, Combine and/or Separate Results
28f Results Processor: Rank Results (by keywords used to find, by number of sites linking to result, etc.)
28g Results Processor: Export Results (to word processor file, to spreadsheet, to database, etc.)
28h Results Processor: Other
30 Most Relevant/Selected Results data store (websites, images, videos, audio, databases, etc.)
100 Input/Output (I/O) Processor
102 Search Processor
104 “GO” button
106 Search term field
108 Search term selected for deletion
110 Search term selected for re-prioritization
112 Re-prioritized search term
114 “Mouse-over” results
116 Ranking Sort Field
118 Address Sort Field

### BACKGROUND OF THE INVENTION

1. Field of the Invention

The present invention is directed to a system and method of enhancing electronic file searching and more particularly to a system and method of determining and/or prioritizing search terms for searching electronic files, including those on and of websites, without requiring in-depth knowledge of the topic being searched.

2. Description of the Related Art

One problem with traditional search engines, such as Google, is that they rely on Searcher(s) supplying a set of initial keywords to search for. This requires that the Searcher(s) have at least some knowledge of the topic being searched, which is usually not the case. Searcher(s) are generally looking for more knowledge on a topic, because they currently aren't very knowledgeable about said topic. As such, Searcher(s) may miss large areas of important search keywords on the search topic. As an example, if a skier was interested in learning more about snow-making machines, they would probably not be aware that one class of snow making machines uses water plus compressed air, while another class of snow making machines uses water plus a very slippery teflon fan, to keep the water from freezing and sticking to the fan. It would be a very unusual for a skier/Searcher to know that an important search term for snow making machines is “teflon.”

Another problem with existing search engines is that they typically present their search results in a limited number of views (often 1), which may not be the best way for the particular Searcher to understand, read and interpret the results. For example, in Google's original search U.S. Pat. No. 6,526,440, they discuss displaying results based on first, the number of times a search term shows up in a result, and second, the number of times a result is linked to by all the other search results. This may not match Searcher(s) needs and/or desires. As examples, Searcher(s) may place a much higher priority on one of the search terms than the others. Or, Searcher(s) might place higher regard to an individual web site that has multiple pages with search terms, rather than a web site that only has one page with search terms. As a final example, Searcher(s) may want to be able to see the results in numerous ways, with Searcher(s) determining how to view/manipulate the results only after they can see what the results are.

Another problem with existing search capabilities is that they generally require active participation of the Searcher(s). That is, Searcher(s) need to stop what they are doing and go and search, often by opening up another application/window. This can disrupt the Searcher(s) “train of thought” and cause loss of productivity.

### SUMMARY OF THE INVENTION

Although others have invented systems and methods of searching electronic files, the present invention attempts to enhance any of these prior systems and methods. Technologically speaking, the present invention is not a search engine. It does not index web pages, nor does it maintain its own database of web pages. While certain embodiments of the present invention may appear to the end-user as a search engine, the present invention instead enhances all steps in a standard search process including the input, the processing and the output/results. These enhancements create a more intuitive search utility with more depth than any other search technology currently offered.

In addition to the aforementioned improvements, the present invention is superior to prior inventions because it has at least one or more of the advantages described below.

One advantage of the present invention is that it reduces the problem of how to search when the searcher is not familiar with the topic that is being searched, such that the searcher does not need to know what keywords are associated with the search topic.

Another advantage of the present invention is that it enhances search results by making them more context-relevant to deliver more specific results and/or more accurate or directed results by eliminating ambiguity of terms (such as badger, the animal vs. Badger, the mascot of UW-Madison, in context).

Another advantage of the present invention is that it enhances search results by making them more targeted results by referencing them to a trusted source of context about the search topic.

Another advantage of the present invention is that it allows a search to commence without the user having in-depth knowledge of the topical area pertaining to the search and/or without the user having to supply keywords and/or key phrases to search for relating to the search and/or search topic.

Another advantage of the present invention is that it allows a search to commence by directly supplying another file, such as a whitepaper, news article or definitional document, to the search for automatic search term selection.

Another advantage of the present invention is that it presents the intermediate keyword results to the searcher, so the searcher can gain an understanding of important keywords on the topic. This presents the searcher with a summary of what the context is about.

Another advantage of the present invention is that it allows the Searcher(s) and/or software to adjust the priority (“weighting”) of the search terms to match their perceived relevancy.

Another advantage of the present invention is that it allows for trusted source(s), one possible source of the context to determine search terms from, to be either a recognized source, such as a database repository on a network, a web site (such as Wikipedia), or a customized source created/modified from the Searcher(s), etc. or any combination of sources/modified sources.

Another advantage of the present invention is that it allows for results to be re-ranked and prioritized based on a custom ranking system or multiple ranking systems, such as: keywords; URL address; description; name; result type (such as image).

Another advantage of the present invention is that it allows for the re-ranking and/or reprioritization mentioned above to be user controlled, after search results are known.

Another advantage of the present invention is that it allows for searching to be a passive event. That is, for a search to commence, and results to be displayed, without interrupting the Searcher(s) from performing their current activity. For example, while writing a document, results found using the current paragraph and/or current document as input to the search could be displayed inside (or outside) the window of the current application.

### BRIEF DESCRIPTION OF THE DRAWINGS

The present invention will become better understood upon consideration of the following detailed description of the invention when considered in connection of the accompanying drawings, in which like reference numerals designate like parts throughout the figures thereof, and wherein:

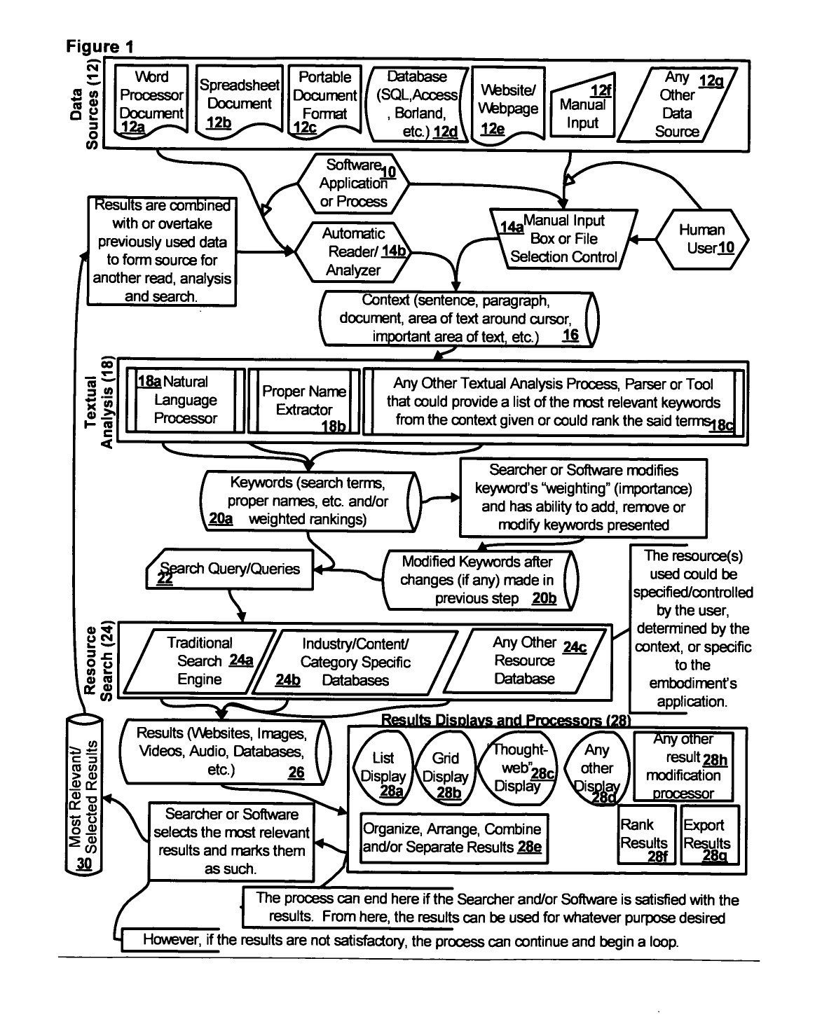

FIG. 1 is a generalized view of the most likely flow of data and processes within the present invention;

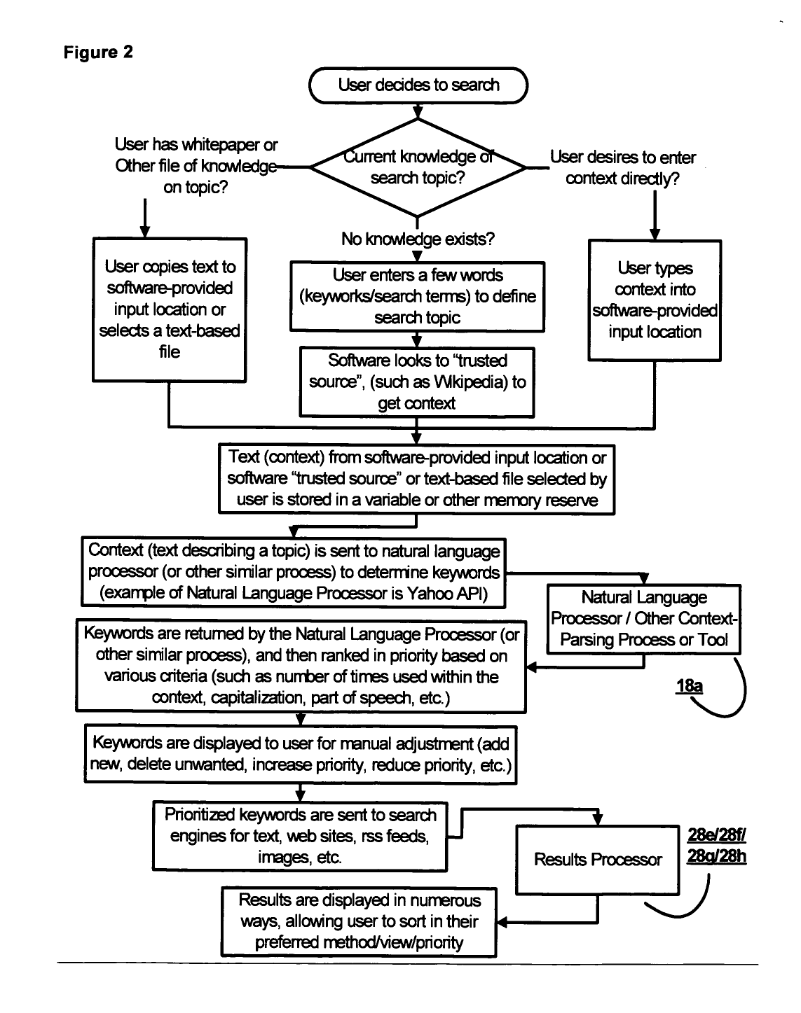

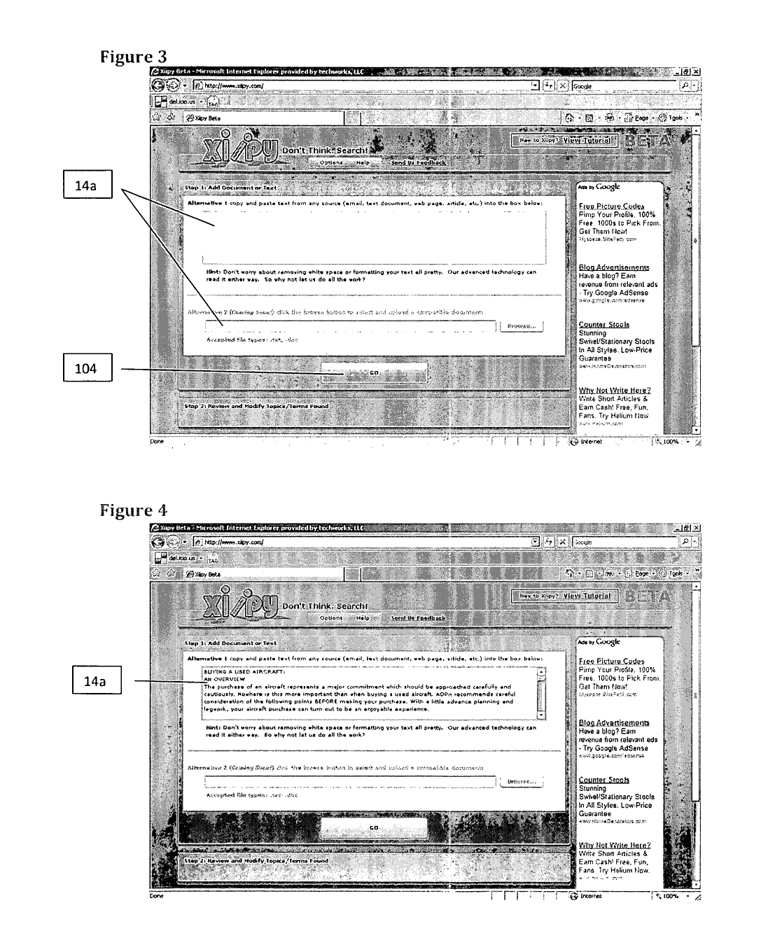

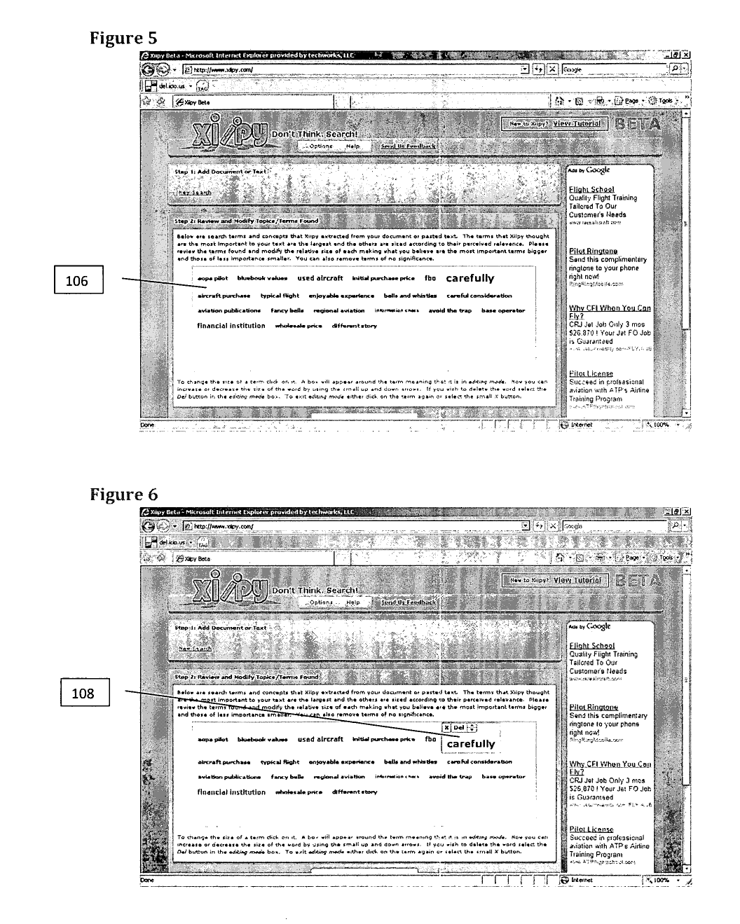

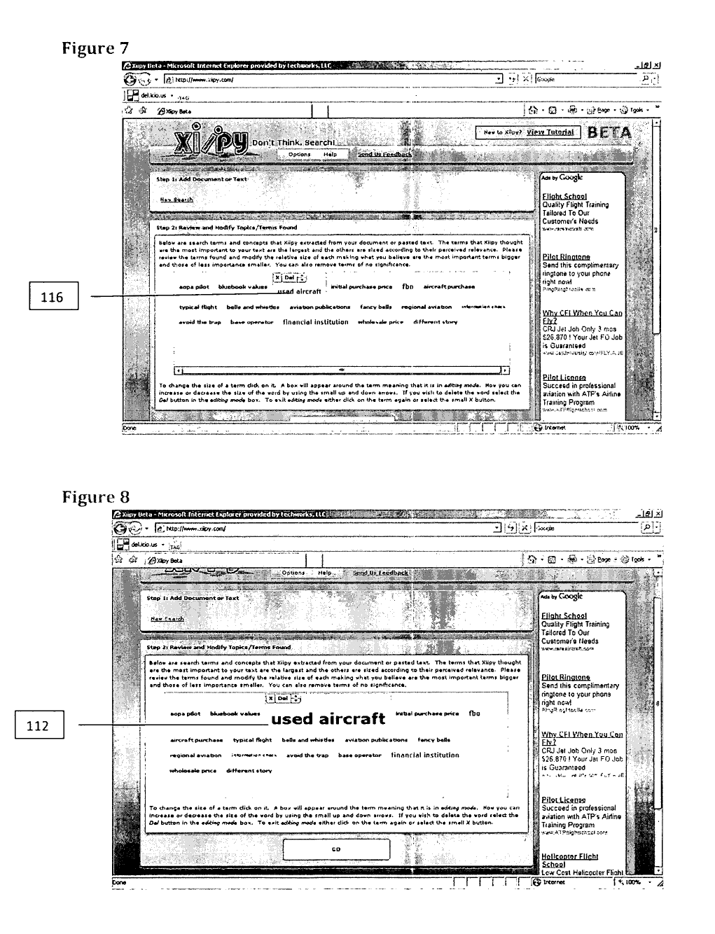

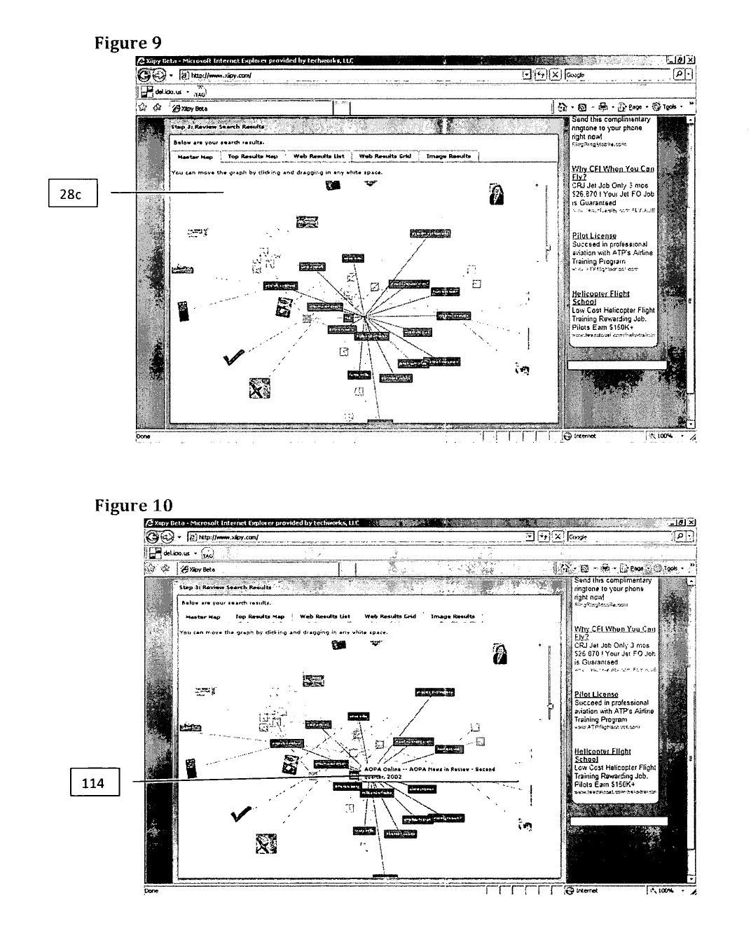

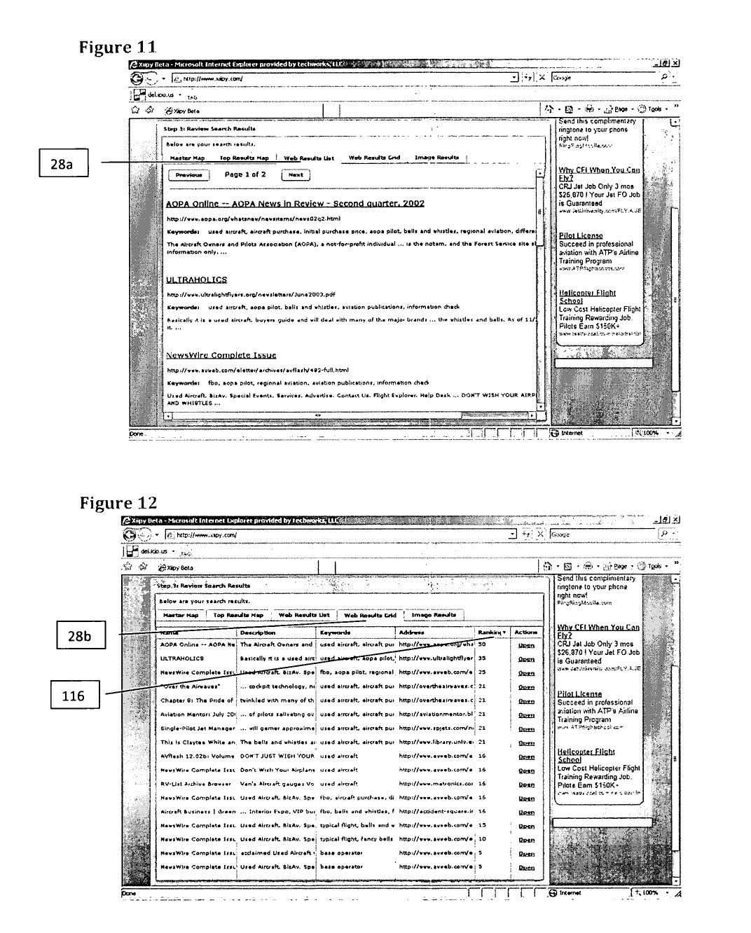

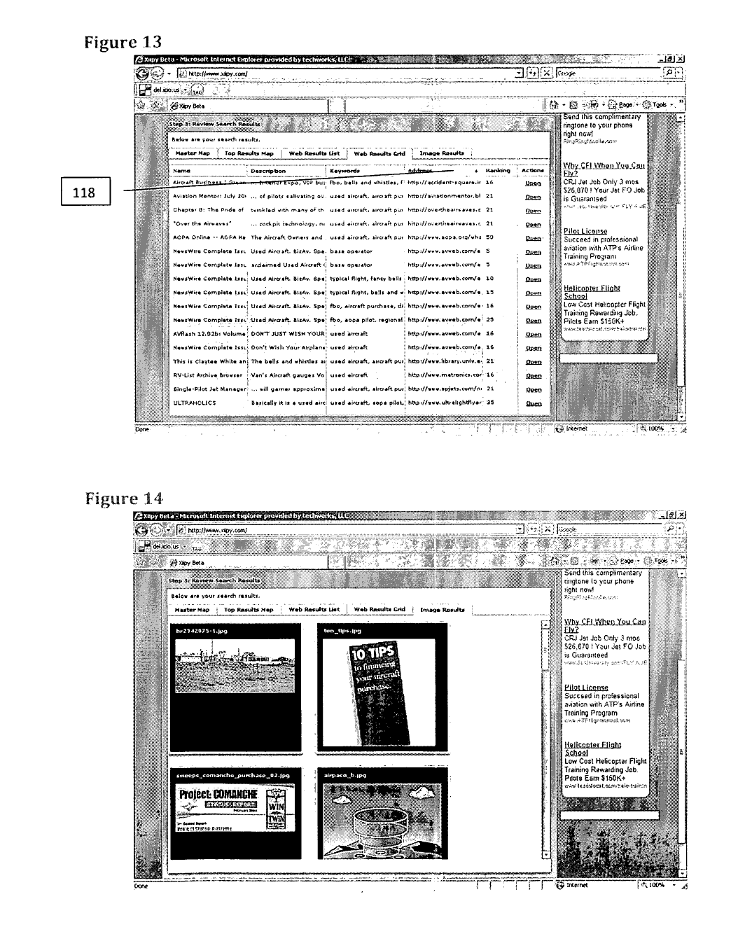

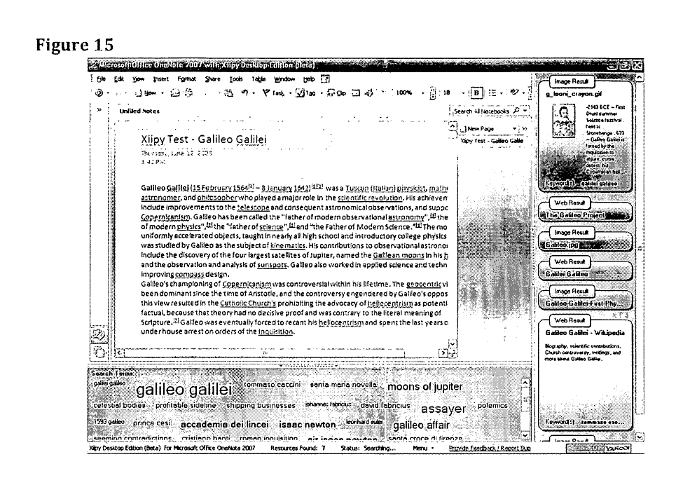

FIG. 2 is a flowchart of processes and user-driven decisions of one preferred embodiment of the present invention;

### DETAILED DESCRIPTION OF THE PREFERRED EMBODIMENTS AND EXPLANATORY CHARTS

The principles and operation of the present invention may be better understood with reference to the drawings and accompanying descriptions.

Before explaining at least one embodiment or explanatory chart of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

As used herein the phrase “context” refers to a plurality of words, names and/or acronyms, for example a sentence, paragraph or any other grouping of words.

The present invention was developed to provide a search utility that offers more relevant, reliable, efficient and timely searches in the situation where the searcher 10 has very little or no prior knowledge of the topic being investigated. To satisfy the proposed goal of more reliable searches, the present invention seeks to perform context-based searches whereby more than singular keywords are analyzed together; instead, entire sentences or more of text are analyzed in order to determine the exact “context” in which the keyword terms are operating. An added advantage of this search method is disambiguation of search queries where multiple definitions' or implications' could exist. For example, if a Searcher 10 entered a keyword into a traditional search engine (like Google, Yahoo!, or MSN) they would get results for all meanings of the word. Imagine the Searcher 10 wanted information about the new satellite navigation system, called Galileo, being developed by the European Union as an alternative to the United States' Global Positioning System. Simply entering the keyword “Galileo” into a traditional search engine would be very inefficient as many of the webpage results returned would instead be related to the 16^{th}-century Italian astronomer, Galileo Galilei. As will be shown in the following examples of various preferred embodiments of the present invention, this inefficiency can be reduced through context-based searches which look at additional words and phrases in the accompanying text to determine exactly the searcher's 10 intended definition of the word. In addition, many of the preferred embodiments of the present invention work to satisfy the stated goal of timeliness in searching and research. Instead of requiring a searcher 10 to switch active windows or take time brainstorming appropriate keywords to search for, many embodiments of the present invention automatically read and analyze the currently active document or application and automatically passes the data found to the context-based search. From there, suggested results that may be useful research sources or media elements can be displayed in a non-obtrusive toolbar or window. These advantages are presented further in descriptions of preferred embodiments and explanatory charts below.

In FIG. 1, a general representation of the present invention, many features common to most of the other preferred embodiments are demonstrated. Because of its general nature, we wish to reassert the non-limiting nature of this figure and all related descriptions. It does not represent all possible embodiments nor does it represent the only path of achieving the present invention's goals. It is not specific to any current embodiment but instead all currently available embodiments employ part or all of the processes demonstrated within the figure. This figure does not claim to represent the entire invention and should only be viewed as the most comprehensive example presented. The invention is not limited to parts, arrangements or details specified in FIG. 1; instead, the scope of the invention should be inferred from the claims of the present invention. The figure is also not specific to any computer operating system or platform.

As shown in FIG. 1 a human Searcher 10 or computer application Searcher 10 initiates the entire process, either by manually inputting data, by sending a data source 12 to the input method 14a/14b (demonstrated by the open-faced arrows along the path between the data source 12 and input methods 14a/14b) or by initiating an automatic reading process through an Automatic Reader or Analyzer 14b. In the case where data was manually entered or a data source 12 was selected, the text or data that was entered or that which is contained within the data source 12 will be stored by the present invention in a context variable data store 16. Here the context 16 refers to a sentence, paragraph, an entire document's contents or any other text/data provided by the Searcher 10 or data source 12. In the case where the data was read and analyzed by the Automatic Reader/Analyzer 14b, the text/data for the context variable data store 16 will be provided by the reader 14b. It may simply pass all text/data in the data source 12 it is reading to the context data store 16, may pass only a most relevant group of text from the data source 12 as determined by the area around the active cursor to the context data store 16, or may pass text/data from the data source 12 to the context data store 16 using any other method to determine the desired text/data. After the context data store 16 is populated, the present invention begins the process of textual analysis 18.

In accordance with the present invention, textual analysis 18 consists of any method used to convert the context 16 to keyword(s) 20a. In one current embodiment, a Natural Language Processor 18a is used to reduce the context 16 to keyword(s) 20a. A Natural Language Processor 18a typically works by analyzing a sentence's grammatical structure. This can then be used to return only nouns and adjectives attached to nouns as keywords 20a. Methods other than using a Natural Language Processor 18a could also be used to achieve the conversion of context 16 to keyword(s) 20a including (but not limited to) a Proper Name Extractor 18b. Each term within the keyword(s) 20a will often be weighted (assigned an importance relative to other terms) using some other textual analysis method 18c. For example in one preferred embodiment, terms are assigned a weighted ranking according to how many occurrences of the word appeared in the context 16. Regardless of the method, after the textual analysis 18 is complete and the keyword(s) data store 20 is populated with data (search terms, proper names, etc. and/or weighted rankings), in some embodiments the Searcher 10 is able to modify (add to, remove from) the set of keywords 20 either through an interface or programmatically. In most embodiments, the Searcher 10 is also able to modify the “weighting” or weighted ranking of each term within the keyword(s) set 20a. If any modification or re-ranking occurs, the resulting data is stored in another data store, the modified keyword(s) data store 20b. If the keyword(s) were at all modified or re-ranked then the modified keyword(s) data store 20b will be used to construct a search query or queries 22, otherwise the unmodified keyword(s) data store 20a will be used to construct a search query or queries 22.

The resource search 24 uses the search query/queries 22 to find results 26. The resource searched could be a traditional search engine 24a like Google, Yahoo! or MSN search, an industry-specific database 24b like LexisNexis, a content/category specific database/resource 24b like a newspaper database, or any other searchable resource 24c. The resource search 24 can search for websites, images, audio, video, or any other form of media and data that the specific database/resource provides.

Once results are returned and the results data store 26 is populated, the results 26 can be displayed and manipulated through one or multiple results displays and processors 28. For example, the results 26 can be simply listed with a list display 28a and/or shown in a graphical web display 28c linking together results 26 and keywords 20a/20b. In addition, results 26 can be manipulated with a results processor 28e/28f/28g/28h. For example, the results 26 could be exported to a computer readable document/data source 12 and/or ordered based on rankings assigned from the keywords 20a/20b which were used to build the search query or queries 22 that were used to find them.

Depending on the embodiment, the process can end here if the Searcher 10 is satisfied with the results 26. From here, the results 26 can be used for whatever purpose desired (research, entertainment, etc.). However, if the Searcher 10 is not satisfied they could re-initiate the whole process using the most relevant results 30 as the context 16 or to build the context 16, depending on the embodiment. For example, the Searcher 10 selects the most relevant results and marks them (using a method provided by the software) as such. These most relevant results 30 are then passed to the Automatic Reader/Analyzer 14b to combine with or overtake previously used data to develop a new context 16 for the entire process to repeat, adding to or replacing the results 26 of the previous iteration.

To further describe the present invention let us look at FIG. 2, which is a flowchart describing one preferred implementation of the present invention showing its primary components.

In general, an Input/Output (I/O) Processor 100 gets input from a Searcher 10 (human user or software process). Context for the search topic will be either: what the user/application entered into the I/O Processor 100; and/or the I/O Processor 100 will pass input to an external Trusted Source 24, which will determine search context, passing context results back to the I/O Processor 100. Once the search context is known, the I/O Processor 100 passes the search context to the Natural Language Processor 18a. The Natural Language Processor 18a determines appropriate keywords to search for, and passes those keywords back to the I/O Processor 100. The I/O Processor 100 optionally either: prioritizes the keywords, displays the keywords results back to the user for user prioritization, passes the keywords to a Search Processor 102 or performs or obtains any combination of the above. Once the keywords have been prioritized, the I/O Processor 100 passes the keywords to a Search Processor 102. The Search Processor 102 performs the search and passes results to a Results Processor 28e/28f/28g/28h. The Results Processor 28e/28f/28g/28h organizes results into different views and passes results back to the I/O Processor 100.

A more detailed description follows: Starting from the beginning of the embodiment's process, a Searcher 10 decides to search for information. In the prototype implementation, a Searcher 10 has 3 choices for entering initial text that will be analyzed for search terms. The Searcher 10 can: enter text directly into Input Area 14a; copy and paste any amount of text (possibly from a web page, white paper, or other source) into Input Area 14a; or browse for and select/enter a file name in Input Area 14a. The Searcher 10 then presses the “GO” Button 104.

An I/O Processor 100 determines if the data entered was a few keywords or if it was context. If it was a few keywords, the I/O Processor 100 passes the keywords to a Trusted Source 24 to obtain context on the search topic. The Trusted Source 24 determines search context, passing context results back to the I/O Processor 100.

Once context on the topic is obtained, the I/O Processor 100 passes the context to a Natural Language Processor 18a. The Natural Language Processor 18a determines appropriate keywords to search for, and passes those keywords back to the I/O Processor 100 to be shown in a Search Term Field 106. Different search terms are shown in differing font sizes based on their relative importance in the context as determined by the number of occurrences. The Searcher(s) 10 then manipulates the Search Term Field 106. The search term can be re-prioritized (more or less important), or can be deleted entirely. The Searcher(s) 10 can also add to the Search Term Field 106 and interact with those added in the same manner as the other search terms 20a/20b. Once the Searcher(s) 10 is satisfied with the search terms 20a/20b and their related priorities, the Searcher(s) 10 presses the “GO” button 104.

Once the keywords have been prioritized and the “GO” button 104 pressed, the I/O Processor 100 passes the keywords to a Search Processor 102. The Search Processor 102 performs the search and passes results to a Results Processor 28e/28f/28g/28h.

The Results Processor 28e/28f/28g/28h organizes results into different views and passes results back to the I/O Processor 100. Examples of this are shown from the current prototype with views of: Master Map 28c, a view connecting keywords and results, showing all keywords that map to a result with a connected line; Web Results List 28a, a “traditional” web result view, with the improvement that results are prioritized based on ranking; Web Results Grid 28b, a grid view of all results, sortable by any Ranking Sort Field 116 of any column heading; Image Results 26, showing that results can be sorted by result type, such as web URL address, file type, etc.

If desired, the User 10 can then interact with the different result views, such as by: getting more information as by Mouse-over Result 114; copying/pasting; clicking to go to results page(s) for more detail; rearranging or sorting, as by a Ranking Sort Field 116 or an Address Sort Field 118. Depending on the search topic, it may be more advantageous for the user to view results: by ranking, to see the initial prioritization of results; by keyword, to see all results associated with a keyword; by URL Address, to see all keywords associated with that result.

Searcher(s) may also be interested in dividing results into different result types. In the prototype implementation, Image Results 26 displays only those results that contain images, and only displays the images off the web site, not any text.

Some other preferred embodiments of the present invention are described below.

In one preferred embodiment of the present invention, the system may be used either from a graphical user interface (GUI), or as a module in another piece of software, such as a word processor, spreadsheet or other program. In another preferred embodiment of the present invention, the system can be used for near-real-time searching within context that can be done automatically including without user prompting. For example, while typing a document into a word processor, this invention can take as input either the entire document, or a portion of the document, such as the current paragraph, determine appropriate search terms, and display results from pictures, web pages, etc. without requiring the user to perform a manual search. These results could be displayed directly in the application the user is working in, where they can be easily referenced, copied, etc. A working prototype of this embodiment is under construction.

The prototype demonstrates the invention capability of automating search, making it a passive event for Searcher(s) 10. This prototype has been built for the Microsoft application OneNote. The majority of the screen displayed is the OneNote application. 2 boxes on the bottom of the screen contain prototype functionality. Image results are displayed horizontally in the left box, web site results are displayed vertically in the right box. The Searcher(s) 10 does not need to do anything. They type normally, interacting with OneNote. In this prototype, the invention takes what they have typed in, feeds it to a Natural Language Processor 18a, determines appropriate search terms 20a, gets results 26, and displays them in the prototype's windows. This is accomplished in near-real time as the user does their work. As Searcher(s) 10 write, they can select relevant images to the section they are working on, and either navigate to the picture, or copy/paste it directly into their paper. Similarly, Searcher(s) 10 can view and/or copy/paste text from the web site results.

In another preferred embodiment of the present invention, Searcher(s) 10 can add details to their existing files, by capturing the content or links from the results and inserting them directly into the existing file.

In another preferred embodiment of the present invention, the I/O Processor 100 optionally either: prioritizes the keywords; displays the keywords results back to the user for user prioritization; passes the keywords to a Search Processor 102; or any combination of the previous.

In another preferred embodiment of the present invention, the context 16 can be either the natural language supplied by User 10, a recognized source, such as a database repository on a network, a web site (such as Wikipedia), a physical person, or a customized source created/modified from the user, etc. or any combination of sources/modified sources Many more possible architectures will be apparent, after reading this description, to a person with ordinary skill in the art. All such architectures are also intended to be covered by this patent.

It is appreciated that features described only in respect of one or some of the embodiments are applicable to other embodiments and that for reasons of space it is not possible to detail all possible combinations. Nevertheless, the scope of the above description extends to all reasonable combinations of the above described features.

Although the invention has been described in conjunction with specific embodiments thereof, it is evident that many alternatives, modifications and variation will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A method of enhancing searches of electronic data store(s) comprising:
(a) accepting context as input; and
(b) reducing context to keywords; and
(c) weighting keywords; and
(d) searching electronic data store(s) using said weighted keywords; and
(e) displaying search results.

2. The method of claim 1, wherein said context is from an electronic file.

3. The method of claim 1, wherein said context is from the META data or other associated data of a multimedia file (video, audio, slideshow, etc.).

4. The method of claim 1, wherein said context is from the content of a multimedia file.

5. The method of claim 1, wherein said context is the result of previous search.

6. The method of claim 1, wherein said context is from a trusted source.

7. The method of claim 6, wherein trusted source is searched for context using keywords provided by searcher.

8. The method of claim 1, wherein said weightings of said keywords are searcher adjustable.

9. The method of claim 1, wherein said keywords in step (c) can be removed by the searcher prior to said searching of electronic data store(s) using said weighted keywords.

10. The method of claim 1, wherein said keywords can be augmented by searcher prior to said searching of electronic data store(s) using said weighted keywords.

11. The method of claim 1, wherein said context is obtained by an automatic reading process.

12. The method of claim 1, wherein said search results are displayed in multiple views and/or viewing formats.

13. The method of claim 1, wherein said search results can be sorted by one or multiple parameters.

14. A system for enhancing searches of electronic data store(s), the system comprising a computing platform for executing a searching application being designed and configured for:
(a) accepting context as input; and
(b) reducing context to keywords; and
(c) weighting keywords; and
(d) searching electronic data store(s) using said weighted keywords; and
(e) displaying search results.

15. The system of claim 14, further comprising a server, being for serving said searching application over the internet.

16. The system of claim 14, further comprising at least one additional computing platform being capable of accessing said searching application and optionally displaying outputs generated by said searching application.

17. The system of claim 14, wherein said electronic data store(s) is stored by at least one additional computing platform capable of communicating with said computing platform.

18. The system of claim 14, wherein said search results are retrieved from a server being in communication with said computing platform.

19. The system of claim 14, wherein said context is from an electronic file.

20. The system of claim 14, wherein said context is from the META data or other associated data of a multimedia file (video, audio, slideshow, etc.).

21. The system of claim 14, wherein said context is from the content of a multimedia file.

22. The system of claim 14, wherein said context is the result of previous search.

23. The system of claim 14, wherein said context is from a trusted source.

24. The system of claim 23, wherein trusted source is searched for context using keywords provided by searcher.

25. The system of claim 14, wherein said weightings of said keywords are searcher adjustable.

26. The system of claim 14, wherein said keywords in step (c) can be removed by the searcher prior to said searching of electronic data store(s) using said weighted keywords.

27. The system of claim 14, wherein said keywords can be augmented by searcher prior to said searching of electronic data store(s) using said weighted keywords.

28. The system of claim 14, wherein said context is obtained by an automatic reading process.

29. The system of claim 14, wherein said search results are displayed in multiple views and/or viewing formats.

30. The system of claim 14, wherein said search results can be sorted by one or multiple parameters.
